(19) United States
(12) Patent Application Publication
(10) Pub. No.: US 2026/0336188 A1
(43) Pub. Date: Oct. 29, 2026

(54) Apparatus and Method for Uniformly Applying Coating Material to a Wire

(71) Applicant: Tre Tau Engineering S.R.L., Pianezza (TO) (IT)

(72) Inventors: Francesco Taiariol, San Giusto Canavese (IT); Piero Degasperi, Trento (IT); Filippo Veglia, Torino (IT)

(21) Appl. No.: 19/122,358

(22) PCT Filed: Oct. 16, 2023
(86) PCT No.: PCT/IB2023/060412

§ 371 Date: Apr. 18, 2025

(30) Foreign Application Priority Data
Oct. 21, 2022 (IT) 102022000021837

(51) Int. Cl. B29C 48/154; B05C 3/00; B05C 3/12; B05C 3/172; B05C 5/02; B05C 11/10; B05D 1/26; B05D 7/20; B29C 48/34; B29C 48/475

(52) U.S. Cl. CPC B29C 48/154; B05C 3/005; B05C 3/12; B05C 3/172; B05C 5/0241; B05C 11/1002; B05C 11/1042; B05D 1/265; B05D 7/20; B29C 48/34; B29C 48/475

(57) ABSTRACT

An apparatus for applying a coating material to a wire includes: a coating chamber for applying a coating material to a wire passing through the coating chamber; an elongate injection channel having a first portion including an opening for receiving a quantity of coating material in a solid-state and a second portion in communication with the coating chamber; a heating element configured to raise the temperature of the coating material as the coating material flows through the injection channel; a pressurizer configured to press the coating material within the injection channel, the pressurizer including a stem and being configured to exert a pressure on the coating material in the injection channel and allow the injection channel to receive the predetermined quantity of solid-state coating material; a breather system including an opening configured to put the first portion of the injection channel in fluid communication with a least one release area.

### BACKGROUND OF THE DISCLOSURE

### 1. the Field of the Disclosure

The present invention relates to the field of apparatus for coating a wire with a layer of coating material. More in detail, the invention relates to a coating apparatus of the type capable of applying a layer of coating material on a wire without using any type of solvent (also referred to as solvent-free coating apparatus in the rest of the present description). An example of a solvent-free coating apparatus can be found in the document EP3192081 on behalf of the same assignee. A solvent-free coating apparatus according to the present invention comprises a coating chamber for applying a coating material to a running wire; an elongate injection channel for receiving, heating, and supplying the coating material to the coating chamber; and a pressurizer configured to press the coating material within the injection channel.

### 2. The Relevant Technology

As fully described in the aforementioned document, one of the key aspects of a solvent-free coating apparatus relies in the ability of accurately maintaining the coating material in the coating chamber under a predetermined constant pressure and temperature. To this end, it is of paramount importance to precisely control both the quantity of coating material supplied to the coating chamber and the pressure applied on it.

According to known coating techniques (based, for example, on extrusion coating) the coating material is typically delivered to the coating apparatus and simultaneously pressurized by means of a single device (e.g., a pump or a screw feeder); although efficient, in terms of cost and space, such kind of devices do not allow to accurately control the quantity of coating material injected into the system and, at the same time, the pressure applied on it; as a result, the coating layer of a wire processed by known coating techniques is typically characterized by poor mechanical and thermal properties. For example, the geometry and the thickness of the coating layer laid on a wire by known coating techniques are usually not adjustable nor finely tunable. Another typical problem of known coating apparatuses is their limited operative range which prevents from employing particularly challenging coating materials. An example of such known coating devices can be found in the U.S. Pat. No. 4,252,755.

### SUMMARY OF THE DISCLOSURE

As opposed to known coating devices, the solvent-free coating apparatus according to the present invention comprises a dedicated feeding system configured to precisely calibrate the quantity of solid-state coating material (e.g., powder, pellets, grains, cartridges etc.) delivered into the injection channel of the coating apparatus. The solvent-free coating apparatus according to the present invention further comprises a dedicated pressurizer configured to press the solid-state coating material after entering the injection channel. By employing two dedicated devices (i.e., a feeder and a pressurizer), the solvent-free coating apparatus according to the present invention allows to precisely control both the quantity of the coating material delivered into the injection channel (also referred to as capacity in the rest of the present description) and, at the same time, the pressure applied on it. Further, the precise control of both capacity and pressure allows to indirectly control the residence time of the coating material within the coating apparatus (i.e., the time interval occurring from the introduction of the coating material into the injection channel to the time instant when the coating material exits the solvent-free coating apparatus). This is particularly relevant when employing challenging coating materials (e.g., thermosetting polymers) that start degrading and setting (e.g., reticulating) as soon as exposed to high temperatures.

As better explained in the rest of the present description, the pressurizer according to the present invention is configured to cause flowing of the coating material through the injection channel towards the coating chamber; at the same time, the injection channel is configured to progressively heat the coating material as it flows towards the coating chamber so as to reach a predetermined viscosity and temperature.

The present invention stems from the desire to overcome few issues which can occur during operation of the solvent-free coating apparatus described in the patent EP3192081, thus providing a coating apparatus improved under many respects.

One of the main challenges related to the coating apparatus described in the aforementioned patent EP3192081 is to guarantee smoothness and regularity of the coated surface of the wire when exiting the coating chamber. In this respect, the uniformity and the homogeneity of the coating material contained inside the coating chamber plays a crucial role; furthermore, it is essential to guarantee that the pressure exerted by the pressurizer on the solid-state coating material contained in the injection channel is uniformly transferred to the liquid-state coating material contained in the coating chamber.

An object of the present invention is to enable the pressurizer to uniformly spread the pressure exerted on the coating material within the injection channel so as to seamlessly transfer it to the coating material contained in the coating chamber.

A further object of the present invention is to allow the air entrapped between the particles of the coating material to come out from the injection channel, avoiding that said air between particles goes into the coating chamber, causing formation of defects on the coated surface of the wire, for example in the form of bubbles distributed on the outer coated surface of the wire.

A further object of the present invention is to reduce the risk of malfunctions during the operations of the pressurizer, such as, for example, a displacement of the pressurizer from its main axis.

In view of achieving these objects, the present invention relates to an apparatus for coating a wire having all the features indicated in the annexed claim 1. The present invention also relates to a method for applying a coating material to a wire and to a pressurizer for pressing coating material in an apparatus according to the present invention.

### BRIEF DESCRIPTION OF THE DRAWINGS

Further objects, features, and advantages of the present invention will become apparent from the following detailed description with reference to the annexed characteristics, given purely by way of non-limiting examples, in which:

FIG. 1 shows a cross-sectioned front view of a preferred embodiment of an apparatus for coating a wire according to the present invention and during a first operating phase;

FIG. 2 shows a cross-sectioned front view of a preferred embodiment of the apparatus according to the present invention and during a second operating phase;

FIG. 3a shows a perspective view of an embodiment of a pressurizer according to the present invention;

FIG. 3b shows an enlarged perspective view of an embodiment of a pressurizer according to the present invention;

FIG. 4 shows a diagram of a method for applying a coating material to a wire according to the present invention.

### DETAILED DESCRIPTION OF THE PREFERRED EMBODIMENTS

In the following description, various specific details are illustrated aiming at a thorough understanding of examples of one or more embodiments. The embodiments can be implemented without one or more of the specific details, or with other methods, components, materials, etc. In other cases, known structures, materials, or operations are not shown or described in detail to avoid obscuring various aspects of the embodiments. The reference to “an embodiment” in the context of this description indicates that a particular configuration, structure or characteristic described in relation to the embodiment is included in at least one embodiment. Therefore, phrases such as “in an embodiment”, possibly present in different places of this description do not necessarily refer to the same embodiment. Moreover, particular conformations, structures or characteristics can be combined in a suitable manner in one or more embodiments and/or associated with the embodiments in a different way from that illustrated here, for example, a characteristic here exemplified in relation to a figure may be applied to one or more embodiments exemplified in a different figure.

The references illustrated here are only for convenience and do not therefore delimit the field of protection or the scope of the embodiments.

In the annexed drawings, reference 100 generally designates a preferred embodiment of an apparatus for applying a coating material to a wire 106 according to the present invention. The apparatus 100 may be used to apply a coating material to any type of wire 106, avoiding the use of solvents as primary agent for applying a coating to a wire 106 while guaranteeing optimal mechanical and thermal properties of the resulting coated wire 106. The wire 106 may comprise any type of metal, such as copper, aluminum, or steel. Copper and aluminum wires 106 are typically used for electrical applications such as a winding of an electromagnet. The coating material can be any type of coating material; for example, the coating material can comprise a plastic coating material such as a thermosetting or a thermoplastic polymer.

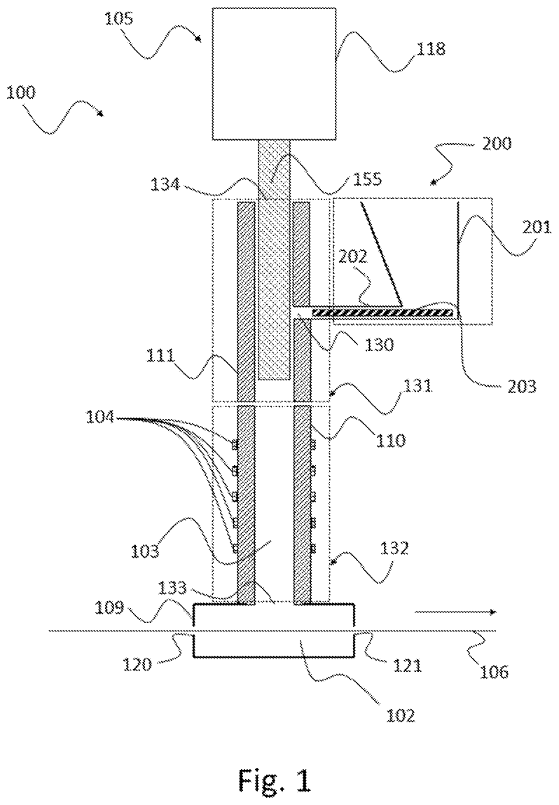

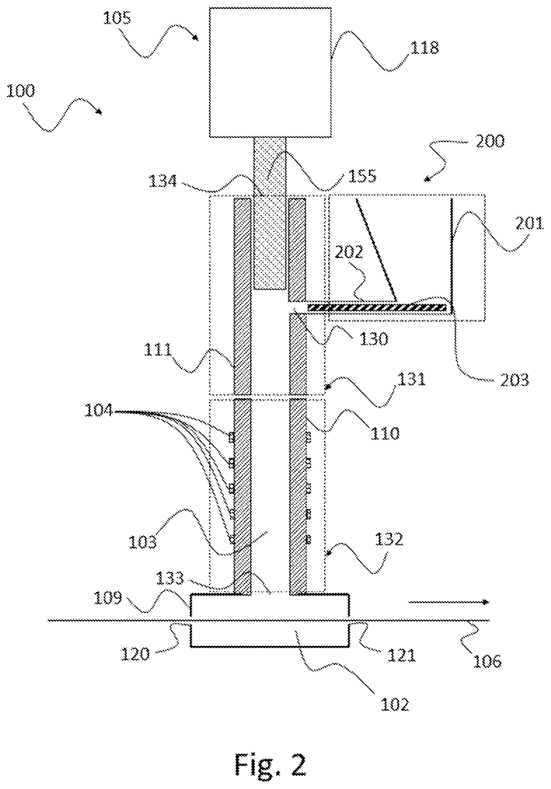

With reference to FIGS. 1 and 2, the coating apparatus 100 according to the present invention comprises a coating chamber 102 for applying a coating material to a wire 106 passing through the coating chamber 102; to this end, the coating chamber 102 comprises an inlet port 120 configured for receiving the wire 106 and an outlet port 121 configured for releasing the wire 106. More specifically, the coating chamber 102 has an inlet port 120 through which a wire 106 can pass and enter in the coating chamber 102 and an outlet port 121 through which the wire 106 can come out from the coating chamber 102 with an outer layer of coating material.

The applied coating can comprise any type of coating material such as, for example, thermosetting or thermoplastic polymer material. Thermosetting materials enable, in general, higher quality coating and perform better at high temperature than thermoplastic materials. The specific type of thermosetting or thermoplastic material that is used may depend on the type of metal of which the wire 106 is made and/or the required properties of the coating according to the final application for which the wire 106 is produced. The thermosetting polymers may comprise any of polyester, epoxy-polyester mixture, polyethylene, polyurethane, polyethylenimine, polyamide, polyimide, polyamide-imide, a thermosetting polyvinyl formal compound, epoxy, polyesterimide, Polyvinyl fluoride (PVF), and other materials. The coating material may be a mixture of any of these polymers as well as with other substances, in particular thermosetting additives. For example, a mixture comprising 60% polyvinyl formal and 40% thermosetting additive, or polyesterimide and amideimide mixture, may be used as coating material.

Thermoplastic polymers can comprise, for example, Perfluoroalkoxy (PFA), Polyether ether ketone (PEEK), Polyether ketone ketone (PEKK), Polyetherimide (PEI), Polyphenylene sulfide (PPS), Fluorinated ethylene propylene (FEP), Ethylene tetrafluoroethylene (ETFE), Polytetrafluoroethylene (PTFE), Polyaryletherketone (PAEK), Polyamide-imides (PAI), Polyvinyl fluoride (PVF).

With reference to FIGS. 1 and 2, the apparatus 100 further comprises an elongate injection channel 103 for receiving a predetermined quantity of solid-state coating material at an opening 130 and for supplying the received coating material to the coating chamber 102 which is arranged in communication with a bottom end 133 of the injection channel 103. More specifically, the injection channel 103 comprises a first portion 131 comprising the opening 130 for receiving solid-state coating material and a second portion 132 configured to be in communication with the coating chamber 102. The injection channel 103 may comprise an elongated hollow body such as for example, a hollow cylinder.

The coating chamber 102 is configured to be in fluid communication with the bottom end 133 of the injection channel 103, for enabling the passage of the coating material from the injection channel 103 to the coating chamber 102 and for allowing smooth propagation of the pressure from the injection channel 103 to the coating chamber 102.

Prior to being fed into the injection channel 103, the coating material is in solid-state such as, for example, powder, solid pellets, chips or cartridges or in other solid forms that are generally known for paints and enamels.

As shown in FIGS. 1 and 2, according to an aspect of the present invention, the coating material can be inserted into the injection channel 103 by means of an automated feeding system 200 configured for driving the coating material within the injection channel 103 through the opening 130. Preferably, the opening 130 is provided at a side portion of the injection channel 103.

According to known technologies, the automated feeding system 200 includes a hopper 201 provided for inserting solid-state coating material, for example in the form of powder, and a duct 202 connecting the hopper 201 with the opening 130. A screw feeding element 203 can be provided within said duct 202, for rotating within the duct 202 and driving the coating material through the duct 202, up to reach the opening 130, thus entering into the injection channel 103.

As shown in FIGS. 1 and 2, the coating apparatus 1 may comprise a support casing comprising a plurality of casings 109, 110, 111 rigidly connected to each other. Said support casing (i.e., each of said casings 109, 110, 111) can be preferably made of heat conductive material, such as metal, in order to ensure that uniform heating of the coating material (in particular due to the heating elements 104 hereinafter described) is maintained within each thermal zone of the apparatus 100.

The first portion 131 of the injection channel 103 can be located, for example, within an upper casing 111, and the second portion 132 can be located, for example, within an intermediate casing 110. Furthermore, the injection channel 103 may comprise a cylinder (in particular, a metal cylinder) comprising both the first portion 131 and the second portion 132 of the injection channel 103 that can be inserted, for example, within one or more of said casings 110, 111 of the apparatus 100.

According to an embodiment of the present invention, said injection channel 103 may have a cylindrical shape with a constant diameter along its entire length, thus avoiding bottleneck-like shape portions which could obstacle flowing of the coating material. This shape of the injection channel 103 enables achievement of an efficient fluid transmission of the coating material towards the coating chamber 102, simple cleaning and maintenance operations of the injection channel 103.

Furthermore, due to the geometry of the injection channel 103 which does not provide any narrowing, a wide opening for the coating material, towards the coating chamber can be provided, so maximizing flow of coating material within the coating chamber 102 while facilitating cleaning and maintenance operations.

As described in detail in the rest of the present description, in order to achieve a desired viscosity of the coating material in the coating chamber 102, the coating apparatus 100 according to the present invention is configured to progressively heat the coating material as it flows through the injection channel 103. More specifically, the coating apparatus 100 is configured to move the solid-state coating material inserted in the first portion 131 of the injection channel 103 to the second portion 132 of the injection channel 103 where the solid-state coating material is progressively melted until reaching a desired viscosity and density.

To this end, the coating apparatus 100 according to the present invention further comprises a pressurizer 105 configured to press the coating material within the injection channel 103 in order to cause flowing of the coating material through the injection channel 103.

The apparatus 100 according to the present invention comprises also at least one heating element 104 which is controllable to progressively raise the temperature of the coating material, as the coating material flows through the injection channel 103, in order to achieve a desired viscosity of the coating material within the coating chamber 102. By accurately controlling the temperatures throughout the injection channel 103 of the coating apparatus 100, molten coating material is directly applied to a wire 106 which passes through the coating chamber 102.

As described in more detail in the rest of the present description, once a required pressure is reached, the pressurizer 105 does not pressurize the coating material any further but it can be configured to maintain a constant predetermined pressure within the injection channel 103 and the coating chamber 102.

As shown in FIGS. 1 and 2, according to an embodiment of the present invention, the pressurizer 105 can comprise a stem 155 which is axially driven along the length of the injection channel 103 by an actuator 118 (for example, an electrically operated actuator).

The pressurizer 105 may further comprise a cylinder rigidly connected to the stem 155 and driven by the actuator 118, whereas the actuator 118 is configured to effectively tune the pressure inside the coating chamber 102 by adjusting dynamically the movement of the cylinder and the stem 155, as the coating material progresses through the injection channel 103.

Furthermore, the stem 155 driven by, for example, the actuator 118 guarantees a quick reaction time for controlling the pressure according to the required high operation speed of the apparatus 100. The details of the actuator 118 are not illustrated in the annexed drawings because they can be provided according to any known configuration and because the removal of such details from the drawings would render the latter more understandable.

In order to avoid direct contact between the pressurizer 105 and the liquid-state coating material contained in the second portion 132 of the injection channel 103, the pressurizer 105 is configured to follow a cyclic working regime whereas each cycle (of said cyclic working regime) comprises a first operating phase (also referred to as “pressing phase” in the rest of the present description; see FIG. 1) for pressing the coating material contained in the first portion 131 of the injection channel 103, and a second operating phase (also referred to as “loading phase” in the rest of the present description; see FIG. 2) for allowing said injection channel 103 to receive a predetermined quantity of solid-state coating material.

More specifically, the pressurizer 105 according to the present invention is configured to operate according to a first operating phase during which the pressurizer 105 exerts a predetermined pressure on the coating material contained in said first portion 131 of said injection channel 103, and a second operating phase during which the pressurizer 105 releases the pressure off the coating material so as to allow said injection channel 103 to receive a predetermined quantity of solid-state coating material. More specifically, during said second operating phase, the pressurizer 105 is in a position that allows said injection channel 103 to receive a predetermined quantity of solid-state coating material.

During the pressing phase, a predetermined pressure is exerted by the pressurizer 105 exclusively on the solid-state coating material contained in said first portion 131 of the injection channel 103.

For the sake of clarity, it is worth noting that, at least during the pressing phase, the quantity of coating material contained in the injection channel 103 progressively diminishes as the wire 106 passing through the coating chamber 102 gradually carries away part of it. As a result, in order to maintain a constant pressure on the coating material in the coating chamber 102, the pressurizer 105 must adapt its position inside the injection channel 103. More specifically, according to an embodiment of the present invention, the stem 155 of the pressurizer 105 can progressively move down the injection channel 103 as the amount of coating material in the injection channel 103 decreases. According to a further aspect of the present invention, in order to avoid any contact between liquid-state coating material and the pressurizer 105, the pressing phase can be terminated before the stem 155 reaches the portion of the injection channel 103 where the coating material is in a liquid state. For example, the pressing phase can be terminated before the pressurizer 105 (e.g., the stem 155) reaches the second portion 132 of the injection channel 103. To this end, said pressurizer comprises a stroke length, the stroke length of the pressurizer 105 being limited to said first portion 131 of the injection channel 103; this substantially means that said stroke length can be configured to limit the travel of the pressurizer 105 to the first portion 131 of the injection channel 103, in particular during the pressing phase. This way, the likelihood of getting the pressurizer 105 in direct contact with the liquid-state coating material contained in the second portion 132 of the injection channel 103 can be minimized.

As shown in FIG. 1, according to a further aspect of the present invention, during the pressing phase, the pressurizer 105 (e.g., the stem 155) can be preferably configured to engage with the opening 130 of the injection channel 103 in order to avoid any pressure leak. As a result, the pressure exerted on the solid-state coating material contained in the first portion 131 of the injection channel 103 can be completely transferred to the second portion 132 of the injection channel 103 and, consequently, to the coating material contained in the coating chamber 102. According to a specific embodiment of the present invention, the stem 155 can be configured to engage with and to cover the opening 130 before getting in contact with the solid-state coating material contained in the first portion 131 of the injection channel 103. For example, as shown in FIG. 1, during the pressing phase, the stem 155 can be configured to fully lock the opening 130 of the injection channel 103 so as to prevent the coating material to leak back to the duct 202 during the pressing phase. As a result, the pressure exerted on the solid-state coating material in the first portion 131 of the injection channel 103 can be fully transferred to the coating material contained in the second portion 132 of the injection channel 103 and, consequently, to the coating material inside the coating chamber 102. It is worth noting that, thanks to the aforementioned feature, the complexity and the maintenance of the coating apparatus 100 is improved.

In addition, as shown in FIG. 2, at the beginning of the loading phase the pressurizer 105 can be configured to release the pressure off the solid-state coating material and to move to a position that allows said injection channel 103 to receive a predetermined quantity of solid-state coating material. According to an embodiment of the present invention, after terminating the pressing phase (or at the beginning of the loading phase), the stem 155 can release the pressure off the coating material by moving upwards along the injection channel 103. In particular, as shown in FIG. 2, in order to allow the injection channel 103 to receive the solid-state coating material, the stem 155 can be configured to fully disengage with the opening 130 (e.g., to unlock the opening 130) so as to connect the duct 202 with the injection channel 103.

Furthermore, the quantity of solid-state coating material to be loaded into the injection channel 103 during the loading phase can be determined so as to achieve a plurality of advantageous effects. For example, the quantity of solid-state coating material to be loaded into the injection channel 103 can be determined as a function of the rate at which the coating material exits the coating apparatus 100 (i.e., the quantity of coating material carried away from the coating chamber 102 by the running wire 106 per time unit). Further, according to a preferred embodiment of the present invention, the quantity of solid-state coating material to be loaded into the injection channel 103 at each loading phase can be determined so as to allow the pressurizer 105 to fully engage with the opening 130 of the injection channel 103 during the pressing phase. More specifically, at the beginning of each pressing phase, the stem 155 moves downwards along the injection channel 103 until reaching the surface of the solid-state coating material inserted in the injection channel 103 during the loading phase. In order to allow a proper lock of the opening 130 during the pressing phase, the upper surface of the solid-state coating material loaded in the injection channel 103 must be in between the opening 130 and the bottom end 133 of the injection channel 103. As a result, when moving downwards, the pressurizer 105 necessarily engages with the opening 130 before reaching the surface of the solid-state coating material.

The quantity of coating material exiting the apparatus 100 can be calculated or estimated according to known techniques. For example, the quantity of coating material exiting the apparatus 100 at each working cycle can be determined experimentally before entering into production.

Alternatively, or in addition, the injection channel 103 can comprise measuring means for measuring the quantity of coating material remaining in the injection channel 103 at the end of each pressing phase. For example, the injection channel 103 can comprise at least one sensor located in the first portion 131 of the injection channel 103 for measuring the quantity of the solid-state coating material contained in said first portion 131 of the injection channel 103. Said at least one sensor can be operatively connected to the feeding system 200 for enabling the feeding system 200 to precisely control the quantity of coating material to be inserted into the injection channel 103 on the basis of the readings of said at least one sensor. In general, the quantity of coating material to be inserted into the injection channel 103 at each loading phase can be determined on the basis of the quantity of coating material contained in the injection channel 103 at the beginning of the loading phase.

Furthermore, while guaranteeing full lock of the opening 130 during the pressing phase, the quantity of coating material inserted into the injection channel 103 can be determined so as to maximize the duration of the pressing phase; as a result, the time ratio between the pressing phase and the duration of a whole working cycle (i.e., also referred to as duty cycle of the apparatus 100) can be maximized with the result of minimizing pressure variations inside the coating chamber 102.

As previously indicated, the coating apparatus 100 according to the present invention has a support casing comprising, for example, a plurality of casings 109, 110, 111 rigidly connected to each other. The support casing can be preferably made of heat conductive material, such as metal, in order to ensure that uniform heating of the coating material, due to the heating elements 104, is maintained within each thermal zone of the apparatus 100.

In the preferred embodiment shown in the drawings, the support casing of the coating apparatus 100 comprises a lower casing 109 comprising the coating chamber 102 and the bottom end 133 of the injection channel 103.

Yet with reference to the preferred embodiment, the support casing comprises an intermediate casing 110 including a plurality of said heating elements 104 and said second portion 132 of the injection channel 103.

Yet with reference to the preferred embodiment, the support casing further comprises an upper casing 111 comprising the first portion 131 of the injection channel 103 and the opening 130 for receiving the coating material.

As previously indicated, said at least one heating element 104 has to be configured to heat different parts of the apparatus in order to progressively raise the temperature of the coating material as it flows through the injection channel 103, for achieving a desired viscosity of the coating material within the coating chamber 102. The use of challenging coating materials such as, for example, thermosetting materials, is possible due to an accurate temperature control and material flow throughout the apparatus 100, preventing the deterioration and the setting of the material within the apparatus 100.

According to an embodiment of the present invention, said at least one heating element 104 comprises a first series of heating elements 104 located within the lower casing 109 and a second series of heating elements 104 located within the intermediate casing 110.

Preferably, the lower casing 109 can comprise multiple holes for enabling passage of the heating elements 104. Preferably, the first series of heating elements 104 comprises two rows of three heating elements 104, each row being located along a respective side of said coating chamber 102.

The intermediate casing 110 can comprise a second series of heating elements 104 which are positioned perpendicular to said injection channel 103. The second series of heating elements 104 can be formed by pairs of heating elements 104, each pair being spaced from each other with constant pitch along the outer surface of the intermediate casing 110, so as to provide uniform heating of the second portion 132 of the injection channel 103.

Thanks to the arrangement described above of the heating elements 104, the apparatus 100 allows to achieve better uniformity of the thermal exchange between the heating elements 104 and the coating material contained in the injection channel 103 and in the coating chamber 102.

According to the embodiment shown in the drawings, which provides a support casing having three casings 109, 110, 111, the coating apparatus 100 has three main temperature zones according to each of the three casings 109, 110, 111. This is a particularly preferable number of temperature zones and casings for effective operation. However, it is possible to provide embodiments which include two temperature zones and casings or more than three casings and temperature zones, without departing from the object of the present invention.

In this respect, at the second portion 132 of the injection channel 103 (e.g., corresponding to the intermediate casing 110), the coating material is heated to a higher temperature than the temperature of the first portion 131 (i.e., the zone of the upper casing 111); the viscosity of the coating material contained in the second portion 132 of the injection channel 103 therefore decreases with respect to the viscosity of the solid-state coating material present in the first portion 131 of the injection channel 103 provided at the upper casing 111. The coating material may be in a liquid state in the second portion 132 of the injection channel 103 and in the zone of the lower casing 109. Preferably, when employing thermosetting polymers, the maximum temperature at the coating chamber 102 is sufficiently high to thoroughly liquefy the coating materials but controlled to be lower than the temperature at which curing of the thermosetting material occurs.

According to an aspect of the present invention, the coating apparatus 100 may be configured to prevent the formation of air bubbles within the liquid-state coating material contained in the coating chamber 102. As already explained above, depending on the granularity of the solid-state coating material employed in the coating process, a certain quantity of air may remain entrapped between the particles of the solid-state coating material contained in the first portion 131 of the injection channel 103. As already explained above, during the pressing phase, the solid-state coating material, along with a certain quantity of air entrapped between the particles of the coating material, is gradually moved towards the second portion 132 of the injection channel 103 where it is progressively melted until reaching a desired viscosity and density; in order to avoid the formation of air bubbles within the molten coating material, it is necessary, during the pressing phase, to allow the air entrapped within the solid state coating material to escape from the first portion 131 of the injection channel 103.

To this end, the coating apparatus 100 according to the present invention comprises a breather system configured to let the air (entrapped between the particles of the solid-state coating material) escape from the first portion 131 of the injection channel 103 during said first operating phase (i.e., the pressing phase). The breather system comprises at least one opening connecting the first portion 131 of the injection channel 103 with at least one release area located outside the injection channel 103 (the release area is not shown in the annexed drawings; however, said release area can comprise, for example, a dedicated room or an open-air area surrounding the coating apparatus 100); said opening may be configured to put the first portion 131 of the injection channel 103 in fluid communication with said release area, in particular during the first operating phase (i. e. the pressing phase).

According to an aspect of the present invention, the breather system can be located within the first portion 131 of the injection channel 102 and can be configured to correctly operate during the whole operation of the apparatus 100 according to the present invention, in particular during the whole pressing phase. In fact, as already described above, during the pressing phase the stem 155 of the pressurizer 105 is configured to move only along the first portion 131 of the injection channel 103 so as to gradually occupy the first portion 131 of the injection channel 103 until its full capacity; in this case, according to an aspect of the present invention, the breather system must be configured to let the entrapped air escape from the injection channel 103 even when the stem 155 fills the first portion 131 of the injection channel 103 in its entirety. In particular, the at least one opening of the breather system may be configured to allow the air flowing from the first portion 131 of the injection channel 103 to said release area even during the pressing phase when the stem 155 operates within the first portion 131 of the injection channel 103.

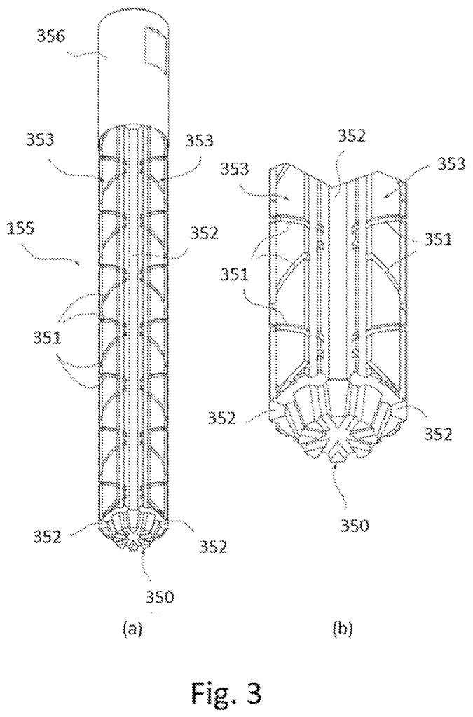

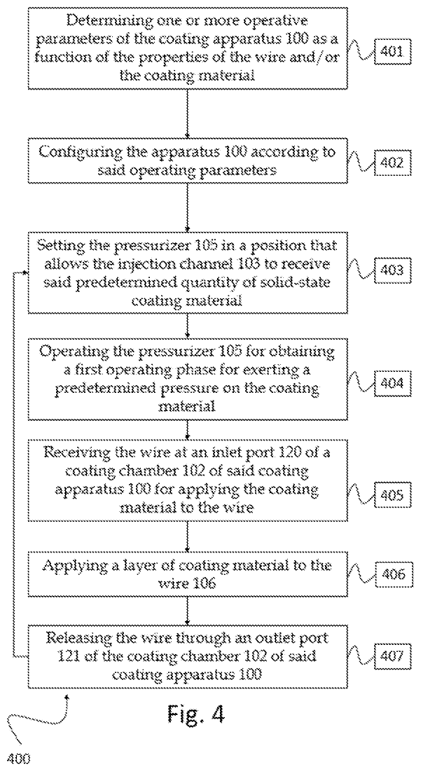

According to an embodiment of the present invention, illustrated in FIGS. 3a and 3b, the stem 155 may comprise an elongated body having an outer face and an upper portion 356 configured for connecting the stem 155 to the actuator 118. The stem 155 can also comprise a tapered end portion 350, for centralizing the pressure exerted on the solid-state coating material contained in the first portion 131 of the injection channel 103; as a result, the pressure exerted by the pressurizer 105 on the coating material contained in the injection channel 103 can be uniformly transferred to the coating chamber 102.

The stem 155 can comprise at least part of said breather system; in particular, at least part of the breather system may be implemented on the outer face of the stem 155 and/or on the inner surface of the elongated hollow body delimiting the injection channel 103. Specifically, said at least one opening may comprise at least one groove extending along the entire length of the outer face of the stem 155.

Alternatively, or in addition, said at least one opening may comprise at least one groove extending along the entire length of the internal surface of the elongated hollow body of the first portion 131 of the injection channel 103. By extending over the entire length of the stem 155 and/or over the internal surface of the first portion 131 of the injection channel 103, the at least one opening or groove is capable of keeping the first portion 131 of the injection channel 103 in fluid communication with a release area located at a top end 134 of the injection channel 103.

For example, according to an embodiment of the present invention, said at least one opening comprises at least one spiral groove 351 extending on the elongated body of the stem 155, for enabling air between particles of the coating material to come out from the injection channel 103 (i.e., by allowing the air to flow through said at least one spiral groove 351 from the first portion 131 of the injection channel 103 until the top end 134 of the injection channel 103), avoiding that said air between particles goes into the coating chamber 102, causing formation of defects on the coated surface of the wire 106, for example in the form of bubbles distributed on the outer coated surface of the wire 106.

Alternatively, or in addition, said at least one opening comprises at least one vertical slot 352 extending parallel to a main axis (not shown in the annexed drawings) of said elongated body. In particular, said at least one opening may comprise a plurality of vertical grooves or slots 352 extending parallel to a main vertical axis of the stem 155. Apart from enabling the removal of air from the injection channel 103, said vertical slots 352 are also configured for reducing the risk of operation malfunctions during movement of the stem 155 within the injection channel 103, due to possible interference between the elongated body of the stem 155 and coating material solidified on the walls of the injection channel 103. Therefore, the vertical slots 352 reduce risk of malfunctions during operation of the stem 155, such as a displacement of the stem 155 from its vertical main axis.

According to the preferred embodiment, the vertical slots 352 are spaced from each other with constant pitch along the outer circumference of the stem 155, so dividing the outer face of the stem 155 into a plurality of septa 353. Preferably, the spiral grooves 351 extend along the elongated body at said septa 353 and have two spiral pattern which are offset in opposite directions. Preferably, the vertical slots 352 have higher depth with respect to said spiral grooves 351. Preferably, the stem 155 can be made of steel, inconel, or a combination of both.

According to an embodiment of the present invention, the elongated body of the stem 155 can comprise, for example, a cylinder, characterized by a featureless surface (e.g., a smooth and/or even surface); according to an aspect of the present invention, the breather system may be implemented by means of a plurality of detachable elements installed on the outer face of stem 155. Such detachable elements can comprise, for example, a plurality of detachable metal slabs and/or metal plates attached magnetically to the surface of the cylinder of the stem 155 or fastened by means of removable attachments (e.g., a plurality of flat bolts). Therefore, in this embodiment, said at least one opening comprises spiral grooves 351 and vertical slots 352 obtained on the elongated body of the stem 155 by means of a plurality of detachable elements associated (i.e. attached magnetically or fastened) to said elongated body of the stem 155. As a result, the pattern and the width of both the spiral grooves 351 and the vertical slots 352 can be adjusted by employing different sets of removable attachments; the pattern can be therefore tailored according to the granularity of the solid-state coating material employed in each specific coating session. This is particularly beneficial when multiple coating materials with different granularity are employed over multiple coating sessions; in this case, the width and the pattern of the spiral grooves and the vertical slots can be adjusted by using, for example, different sets of detachable metal slabs and/or metal plates characterized by different shapes and size. As a result, the same stem 155 can be advantageously employed over multiple coating sessions and with different coating materials by simply reconfiguring the detachable metal slabs and/or plates on the surface of the cylinder of the stem 155.

According to an aspect of the present invention, the release area can be set to a negative air pressure with respect to the air pressure in the injection channel 103 (i.e., a pressure at least lower than the air pressure in the injection channel 103 or lower than the ambient air pressure) so as to force the air entrapped within the particles of the coating material to flow from the injection channel 103 to said release area. To this end, the apparatus 100 according to the present invention can comprise means for setting a first air pressure inside the release area whereas said first air pressure is lower than a second air pressure inside the injection channel 103. Said means for setting a first air pressure inside the release area can comprise, for example, a ventilation system continuously attempting to remove air from the release area.

With reference to the temperature management during operation, preferably, the support casing is shaped so that, in the mounted configuration of the apparatus 100, multiple gaps are provided between at least two casings 109, 110, 111, in order to let flow air between the casings 109, 110, 111 and avoid overheating of the apparatus 100 for heat conduction due to the contact between the casings 109, 110, 111.

Thanks to these gaps, the heat transmission through the casings 109, 110, 111 of the coating apparatus 100 is dramatically reduced, enabling easy management of the different temperatures in the first portion 131 and in the second portion 132 of the injection channel 103.

According to another advantageous features of the invention, the apparatus 100 may comprise an outer casing (not shown in the annexed drawings) made of insulating material, for covering at least said lower casing 109.

For example, the outer casing of insulating material may cover both the lower casing 109 and the intermediate casing 110, enabling the coating chamber 102 to reach very high temperatures (for example, higher than 450° C.) to allow a proper melting of a wide range of polymers.

In the following of the present description there will be described in detail a method 400 for applying a coating material to a wire 106 by means of the apparatus 100 according to the present invention.

At step 401, the value of one or more operative parameters of the coating apparatus 100 are determined (for example, by a control unit comprised in the apparatus 100) as a function of one or more properties of the wire 106 and/or as a function of one or more properties of the coating material to be applied to said wire 106. Said operative parameters can comprise, for example, the power of at least one heating element 104, the feeding speed of the wire 106, the pressure to be exerted on the coating material by the pressurizer 105, the width and the pattern of the spiral grooves and the vertical slots of the pressurizer 155, etc.

For example, the width and the pattern of the spiral grooves and the vertical slots of the pressurizer 155 can be determined (for example, by said control unit) on the basis of the properties (for example, the granularity) of the coating material to be applied on the wire 106.

At step 402, the coating apparatus 100 is configured to operate according to the one or more operative parameters determined at step 401. For example, the width and the pattern of the spiral grooves and the vertical slots of the pressurizer 105 can be set according to the operative parameters determined at step 401.

The method 400 according to the present invention further comprises a step 403 wherein the pressurizer 105 is operated according to said loading phase (i.e., setting the pressurizer 105 in a position that allows said injection channel 103 to receive said predetermined quantity of solid-state coating material); in particular, according to an embodiment of the present invention, the stem 155 of the pressurizer 105 is driven at a raised position, for enabling input of coating material into the injection channel 103 by means, for example, of the screw feeding element 203 of the automated feeding system 200.

The method 400 further comprises a step 404 wherein the pressurizer 105 is operated according to said pressing phase (i.e., exerting a predetermined pressure on the coating material in the injection channel 103). For example, according to an embodiment of the present invention, the actuator 118 of the pressurizer 105 moves the stem 155 from the raised position and applies the desired pressure to the coating material within the injection channel 103 of the coating apparatus 100.

The coating material is pressurized by the stem 155 to the pressure at which it is required to apply the coating material on the wire 106. Once this pressure is reached, the stem 155 does not pressurize the coating material any further but is controlled to maintain the pressure within the injection channel 103, and the coating chamber 102, almost steady at the desired value for applying the coating material on the wire 106.

The gradual increase of temperature of the coating material occurs as the coating material progresses through the injection channel 103. Specifically, at the second portion 132 of the injection channel 103, the coating material is progressively heated until reaching a predetermined temperature, thus turning into a liquid state and filling the coating chamber 102.

The method 400 according to the present invention further comprises a step 405 wherein the wire 106 is received at the inlet port 120 of the coating chamber 102 of said coating apparatus 100 for applying said coating material to the wire 106. The wire 106 passing through the coating chamber 102 is therefore coated by the liquid coating material located within the coating chamber 102.

At step 406, the wire 106 is coated by the liquid coating material, carrying away from the chamber 102 an amount of coating material which corresponds to the coating layer applied on the outer surface of the wire 106; at step 406, a layer of coating material is therefore applied to the wire 106.

The method 400 further comprises a step 407 wherein the wire 106 is released through an outlet port 121 of the coating chamber 102.

After step 407, the pressurizer 105 is configured to release the pressure off the coating material; the method 400 according to the present invention then cycles back to step 403 (if the properties of the wire 106 and/or of the coating material are the same of the previous cycle), otherwise the method 400 cycles back to step 401 (if the properties of the wire 106 and/or of the coating material are different from the ones of the previous cycle).

The wire 106 obtainable by the method 400 according to the present invention is characterized by unique thermal and mechanical properties which are not achievable by known coating techniques; for example, the method 400 is capable of obtaining a wire 106 characterized by optimal adhesion between the wire and the coating layer. While guaranteeing optimal adhesion, the apparatus 100 is also capable of applying in one step (i.e., a single transit of the wire 106 through the apparatus 100) a layer of coating material much thicker than the layer of coating material achievable by known coating techniques; in this case, the thickness of the coating layer is in fact strongly limited by the presence of solvents in the coating material which evaporate after the coating procedure. For this reason, in order to achieve a predetermined thickness of the coating layer, it is often necessary to apply multiple layers of coating material on the wire thus compromising the uniformity of the resulting coating layer. On the contrary, the apparatus 100 according to the present invention is capable of applying on the wire 106 a layer of coating material much thicker than that achievable by known techniques, thus minimizing the number of layers of coating material. The wire 106 according to the present invention is therefore characterized by optimal properties in terms of, for example, adhesion, uniformity, smoothness, etc.

Thanks to the above described structural and functional characteristics of the coating apparatus 100, an easily maintainable coating apparatus 100 for applying a coating material to a wire 106 is achieved, which is capable of eliminating any air from the liquid coating material in the injection channel 103 thus avoiding deterioration of the coating material and formation of bubbles distributed on the outer coated surface of the wire 106.

Naturally, while the principle of the invention remains the same, the details of construction and the embodiments may widely vary with respect to what has been described and illustrated purely by way of example, without departing from the scope of the present invention.

1. An apparatus for applying a coating material to a wire, said apparatus comprising:
a coating chamber for applying a coating material to a wire passing through the coating chamber, wherein the coating chamber comprises an inlet port configured for receiving the wire and an outlet port configured for releasing the wire;
an elongate injection channel comprising a first portion and a second portion, said first portion comprising an opening for receiving a predetermined quantity of coating material in a solid-state, said second portion being in communication with the coating chamber;
at least one heating element configured to raise the temperature of the coating material as the coating material flows through the injection channel;
a pressurizer configured to press the coating material within said injection channel, said pressurizer comprising a stem and being configured to operate according to a first operating phase during which the pressurizer exerts a predetermined pressure on said coating material in said injection channel, and a second operating phase during which the pressurizer is in a position that allows said injection channel to receive said predetermined quantity of solid-state coating material;
a breather system comprising at least one opening configured to put the first portion of the injection channel in fluid communication with a least one release area, in particular during said first operating phase of the pressurizer.

2. The apparatus according to claim 1, wherein said stem comprises an elongated body and said at least one opening comprises at least one groove extending on said elongated body.

3. The apparatus according to claim 2, wherein said at least one groove comprises at least one spiral groove extending on said elongated body and/or at least one vertical slot extending parallel to a main axis of said elongated body.

4. The apparatus according to claim 1, wherein said at least one opening comprises at least one spiral groove extending on an inner surface of said injection channel and/or at least one vertical slot extending parallel to a main axis of the injection channel.

5. The apparatus according to claim 2, wherein said at least one opening comprises at least one spiral groove and/or at least one vertical slot obtained on the elongated body of the stem by means of a plurality of detachable elements associated to said elongated body.

6. The apparatus according to claim 5, wherein said plurality of detachable elements comprise at least one metal slab and/or one metal plate.

7. The apparatus according to claim 1, wherein said apparatus further comprises means for setting a first air pressure inside the release area, said first air pressure being lower than a second air pressure inside the injection channel.

8. A pressurizer for pressing solid-state coating material in a coating apparatus according to claim 1, wherein said pressurizer comprises a stem, said stem comprising at least one groove extending on an elongated body of said stem and/or at least one vertical slot extending parallel to the main axis of said stem.

9. A method for applying a coating material to a wire by means of an apparatus according to claim 1, comprising:
determining one or more operative parameters of the coating apparatus as a function of one or more properties of the wire and/or as a function of one or more properties of the coating material;
configuring the coating apparatus according to said one or more operative parameters;
setting the pressurizer in a position that allows said injection channel to receive said predetermined quantity of solid-state coating material;
operating said pressurizer for obtaining a first operating phase for exerting a predetermined pressure on said coating material in said injection channel wherein, during said first operating phase, said breather system is configured to let the air escape from the first portion of the injection channel
receiving the wire at an inlet port of a coating chamber of said coating apparatus;
applying a layer of coating material to the wire;
releasing the wire through an outlet port of the coating chamber of said coating apparatus.

10. (canceled)
